(19) United States
(12) Patent Application Publication
(10) Pub. No.: US 2005/0247165 A1
(43) Pub. Date: Nov. 10, 2005

(54) Tool for extracting damaged fasteners and method of using same

(75) Inventors: Rene Arriens, Merritt Island, FL (US); Steven J. Jezowski, Mims, FL (US); Andrew J. Knight, Cocoa, FL (US)

Correspondence Address: GREENBERG-TRAURIG, 1750 TYSONS BOULEVARD, 12TH FLOOR, MCLEAN, VA, 22102, US

(73) Assignee: United Space Alliance, LLC, Cape Canaveral, FL (US)

(21) Appl. No.: 11/110,690

(22) Filed: Apr. 21, 2005

Related U.S. Application Data
(60) Provisional application No. 60/563,804, filed on Apr. 21, 2004.

(51) Int. Cl. B25B 13/50

(52) U.S. Cl. 81/53.2

(57) ABSTRACT

A tool for extracting damaged fasteners which reduces foreign object debris, and a method of using the same. The tool preferably includes a collet, which can be constricted around the damaged fastener, an outer wheel, a jam wheel, a jam tube, a drill bit, and a drill stop. The tool is preferably configured such that the drill stop prevents overdrilling. The collet is preferably secured around the damaged fastener by turning the jam wheel, and the outer wheel can be turned in an effort to remove the fastener. If the fastener cannot be removed, the drill bit is applied until the fastener can be extracted. The design of the tool is such that foreign object debris created during this process is preferably contained within the tool itself, thus reducing contamination.

### PRIORITY CLAIM

The instant application is related to, and claims the benefit of, Provisional U.S. Patent Application Ser. No. 60/563,804, which is incorporated by reference herein in its entirety.

### GOVERNMENT RIGHTS

The invention described herein was made in the performance of work under NASA Contract No. NAS9-20000 and is subject to the provisions of Section 305 of the National Aeronautics and Space Act of 1958{42 U.S.C. 2457}.

### FIELD OF THE INVENTION

The present invention relates to the field of mechanical tools, and more particularly provides a tool for extracting screws and other such fasteners.

### BACKGROUND OF THE INVENTION

Threaded fasteners, such as but not limited to wood screws, machine screws, bolts, and the like, routinely break or otherwise become damaged and must be extracted or removed from the part to which they are secured. Unfortunately, the damage frequently occurs when the part is being disassembled, and without completely removing the fastener, the part cannot be disassembled. The prior art has attempted to address the need to extract broken or otherwise damaged fasteners from the part to which they are fastened. The following disclosures evidence the approaches undertaken by the prior art:

U.S. Pat. No. 4,078,458, to Berendzen, the teachings of which are incorporated herein by reference in their entirety, proposes a screw extractor that has, as its leading portion, a simple drill bit, and as a following portion an extractor bit which grippingly binds against the internal walls of a discrepant screw so that the screw can be removed with an unscrewing motion. The entire assembly is capable of being inserted into a standard drill chuck and operated without the need to switch from drilling mechanism to extraction bit.

U.S. Pat. No. 4,688,315, to Jannke, the teachings of which are incorporated herein by reference in their entirety, proposes a screw extractor tool and a method of using the tool. The tool includes a tubular end portion with cutting teeth. It can be used to cut away exterior portions of an embedded screw or to bore into the screw and exert unscrewing force.

U.S. Pat. No. 4,777,850, to Polonsky, discloses a combination tool capable of extracting bolt fasteners. The extraction mechanism is combined with a drill head so that the drilling and extracting steps are performed in the same operation. A drive head is provided for enhanced performance.

U.S. Pat. No. 5,031,487, to Polonsky, discloses a right-hand threaded shaft having a left-hand drill bit at its lower end. The shaft has an invertible collet which tapers toward its lower end and carries exterior left-hand threads. Because the shaft is split and expandable, it is capable of acting as a gripping mechanism once the drilling portion of the bit is extended into the broken fastener.

### SUMMARY OF THE INVENTION

While the prior art fastener extractors work in certain situations, the prior art tools are not particularly useful in clean room and other such environments where it is necessary to avoid the introduction of even trace amounts of particulate matter. Accordingly, the present invention is directed to a fastener extraction tool that substantially obviates one or more of the problems due to limitations and disadvantages of the related art.

An object of the present invention is to capture and retain as much of the extracted fastener as possible, thereby limiting contamination of the surrounding environment.

Another object of the present invention is to provide a jam wheel to tighten the tool onto the fastener head.

A further object of the present invention is to provide a manual hand wheel to facilitate extraction.

Still another object of the present invention is to provide a drill mechanism which includes a drill stop and gripping means.

Additional features and advantages of the invention will be set forth in the description which follows, and in part will be apparent from the description, or may be learned by practice of the invention. The objectives and other advantages of the invention will be realized and attained by the structure particularly pointed out in the written description as well as the appended drawings.

The present invention provides a tool capable of extracting broken, stripped, cross-threaded, or otherwise damaged fasteners from the part which they secure. The present invention includes a head grip that is preferably tightened around any exposed portions of the fastener, and drill-out components designed to fit inside a standard fastener cavity without damaging nearby structures. By gripping exposed portions of the fastener, foreign objects and debris that result from the removal process can be contained within the tool so that foreign particles are not left in the vicinity of the removed fastener. A drill stop is also preferably included to prevent overdrilling, and a manual hand wheel facilitates extraction.

Once the tool is adjusted for the depth of the remaining portion of the fastener and is properly seated, the jam wheel is used to tighten onto any exposed portion of the fastener, such as a screw head. This connection alone may facilitate removal by spinning the hand wheel. If not, the exposed portion can be drilled out and the balance of the fastener extracted by a gripping means, such as, but not limited to, a threaded gripping means.

It is to be understood that both the foregoing general description and the following detailed description are exemplary and explanatory and are intended to provide further explanation of the invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a perspective view of a hatch used in the Space Shuttle program.

FIG. 2 is an exploded view of components utilized in a preferred embodiment of the present invention.

FIG. 3 is a profile view of an assembled fastener extractor tool according to a preferred embodiment of the present invention.

FIG. 4 is a profile view of a drill stop assembly as configured in a preferred embodiment of the present invention.

FIG. 5 is a perspective view of a jam tube bottom end with a portion of a collet bottom end extending therefrom.

FIG. 6 is a top perspective view of a fastener extraction tool according to a preferred embodiment of the present invention.

FIG. 7 is a perspective view of a screw being removed by a fastener extraction tool according to a preferred embodiment of the present invention.

FIG. 8 is a profile view of a fastener which has been removed using a screw extraction tool according to a preferred embodiment of the present invention.

### DETAILED DESCRIPTION OF THE PREFERRED EMBODIMENT

Reference will now be made in detail to the preferred embodiments of the present invention, examples of which are illustrated in the accompanying drawings.

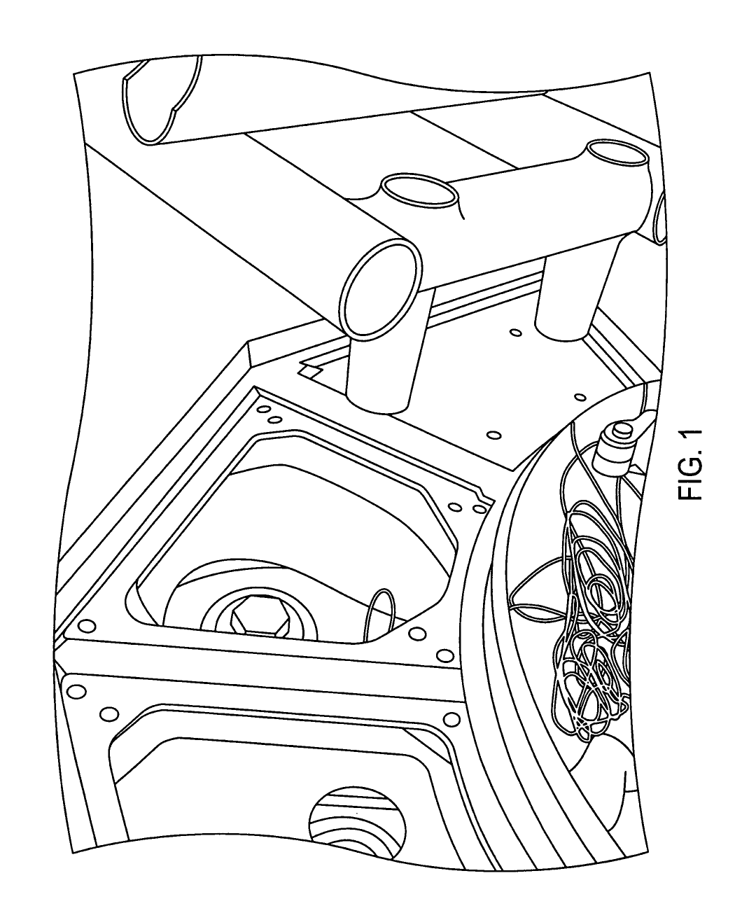

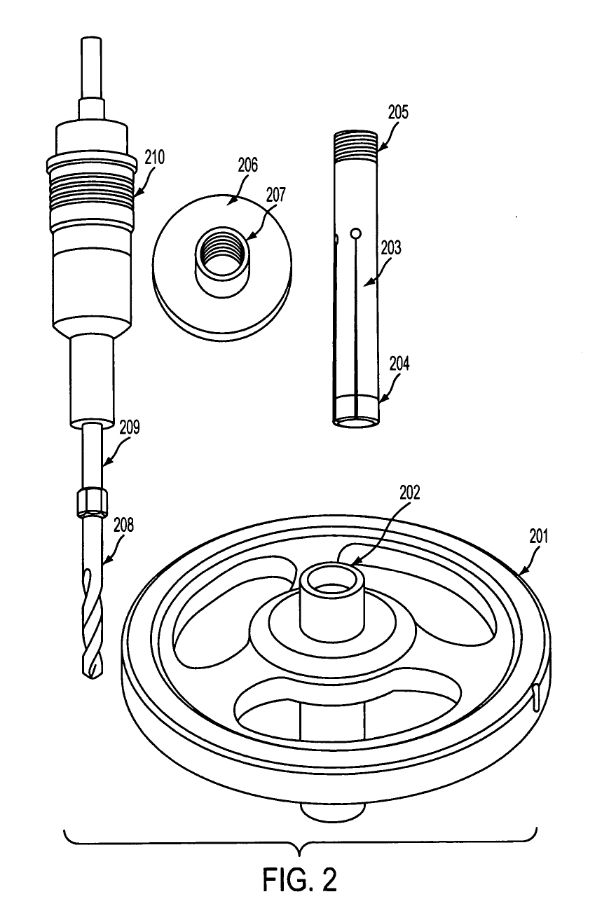

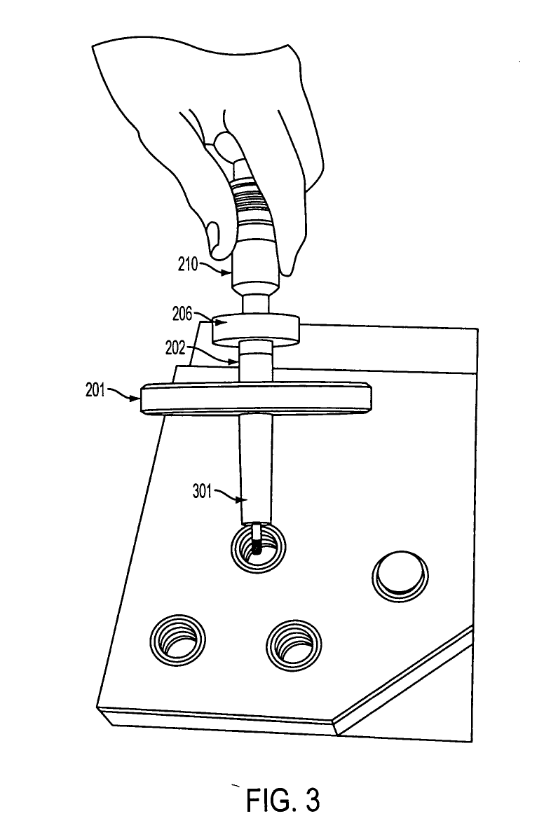

Screws, bolts, and other fasteners are used daily in a wide variety of fields, and the majority of the time, the particles created during the removal of a damaged fastener can simply be cleaned from the area without any significant negative effects. However, in certain situations, introduction of even trace amounts of particles can have serious consequences. For example, FIG. 1 is a perspective view of a portion of the airframe of a Space Shuttle. This airframe is generally covered in heat dissipating tiles, similar to the tile illustrated in FIG. 3. These tiles generally attach to the airframe by a series of screws, thus allowing the tiles to be removed, inspected, and, if need be, replaced. Ceramic plug cavities 302 are embedded within the tiles to permit attachment of the tiles to the airframe while reducing the possibility of damaging the tiles as fasteners are installed or removed. Ceramic caps are typically placed over the ceramic plug cavities after the tiles have been attached to the airframe to reduce drag and shield the screws. Removal and installation of tiles increases the possibility that a screw or other fastener will fail, and removal of such a failed screw using traditional screw extractors results in foreign object debris, or FOD. Introduction of FOD into a ceramic plug cavity may damage or break the ceramic cap, thereby allowing extremely hot gases to enter the tile during reentry. This, in turn, may cause structural damage and/or failure, which may result in a potentially catastrophic failure. It is therefore preferable that removal of any damaged fasteners be done in such a manner as to create as little FOD as possible.

Furthermore, damaged fastener extraction time, including clean up time, can be on the order of an hour per extracted fastener using traditional screw extractors. Many pre-launch procedures are time-critical, with only a minimal time during which any failures can be addressed. Should a fastener become damaged during such a time, a tool which can quickly remove the damaged fastener would be advantageous.

The present invention is directed to a fastener extraction tool which preferably limits the ability of FOD to escape the tool, and can be designed to work in specific physical environments. FIG. 2 is an exploded view of components utilized in a preferred embodiment of the present invention. At the heart of the present invention is collet 203. In one embodiment, collet 203 preferably contains one or more slots beginning at or near collet bottom end 204 so that collet bottom end 204 can be constricted and thereby caused to tighten around an object contained within collet bottom end 204. Collet top end 205 is preferably threaded or otherwise configured to facilitate mating with jam wheel 206 by way of a complementary connector 207 in jam wheel 206. Collet 203 is preferably made of hardened steel or other, high tensile strength material. Collet 203 is preferably inserted within jam tube 202 through the bottom of jam tube 202. Collet 203 is preferably designed to grip the head of an MD112-1003-xxx type screw, with washer, and jam tube 202 is preferably designed to fit in a ⅝″ diameter ceramic insert. While these dimensions are presently preferred, it should be apparent to one skilled in the art that alternative collet and jam tube configurations may be substituted therefor without departing from the spirit or the scope of the invention.

FIG. 3 is a profile view of an assembled fastener extractor tool according to a preferred embodiment of the present invention. As illustrated in FIG. 3, jam tube 202 is preferably tapered near its bottom end 301. Jam tube bottom end 301 is preferably large enough to comfortably receive collet top end 205, while also small enough to force collet bottom end 204 to constrict as collet bottom end 204 is engaged by jam tube 202.

Once collet 203 has been inserted into jam tube 202, collet 203 is preferably mated with jam wheel 206. By rotating jam wheel 206, collet 203 is raised within jam tube 202, which causes collet bottom end 204 to be gradually drawn up within jam tube 202, thereby causing collet bottom end 204 to constrict. In an alternative embodiment, collet 203 may fit inside jam tube 202, and as jam wheel 206 is rotated, collet end 204 may be pressed into the tapered end of jam tube 202, causing collet end 204 to tighten.

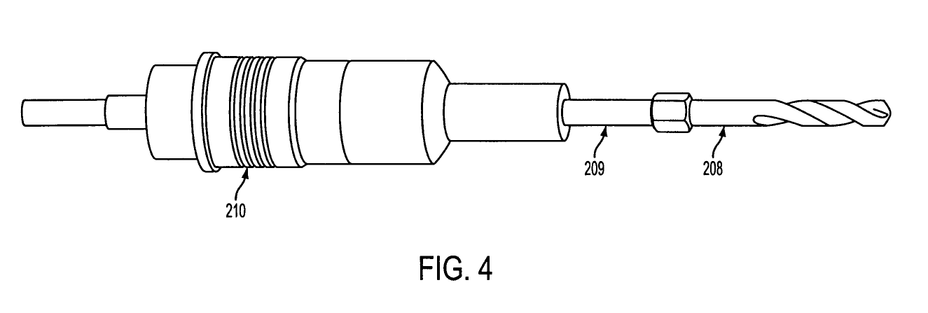

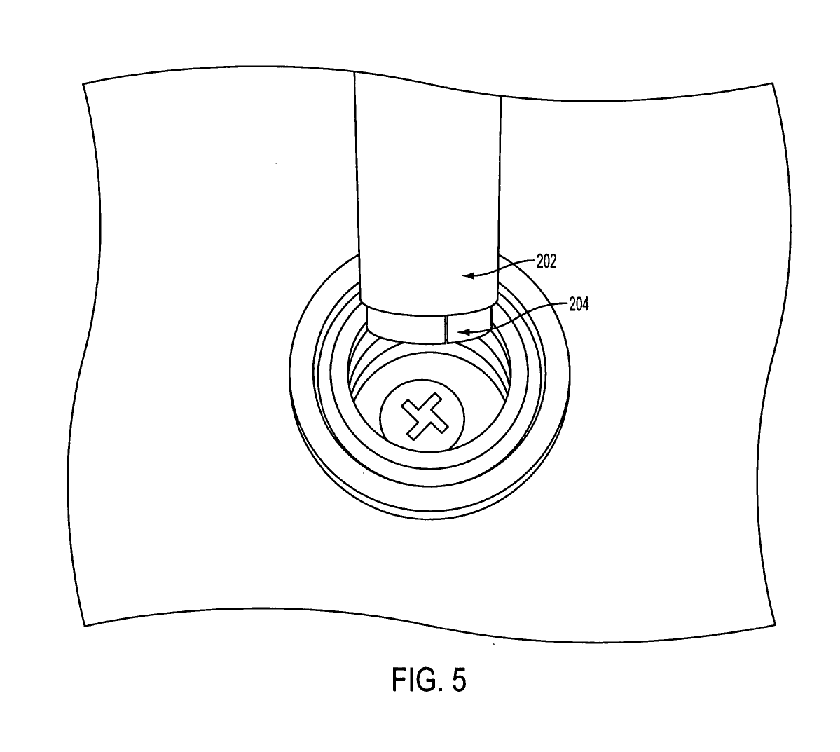

FIG. 4 is a profile view of a drill stop assembly as configured in a preferred embodiment of the present invention. Drill bit 208 and drill shaft 209 can preferably be received by collet top end 205 and jam wheel 206 to allow drill bit 208 to access the item contained within collet bottom end 204. In one embodiment, drill bit 208 may be left-hand threaded, which allows the bit to rotate the fastener when the bit engages the fastener.

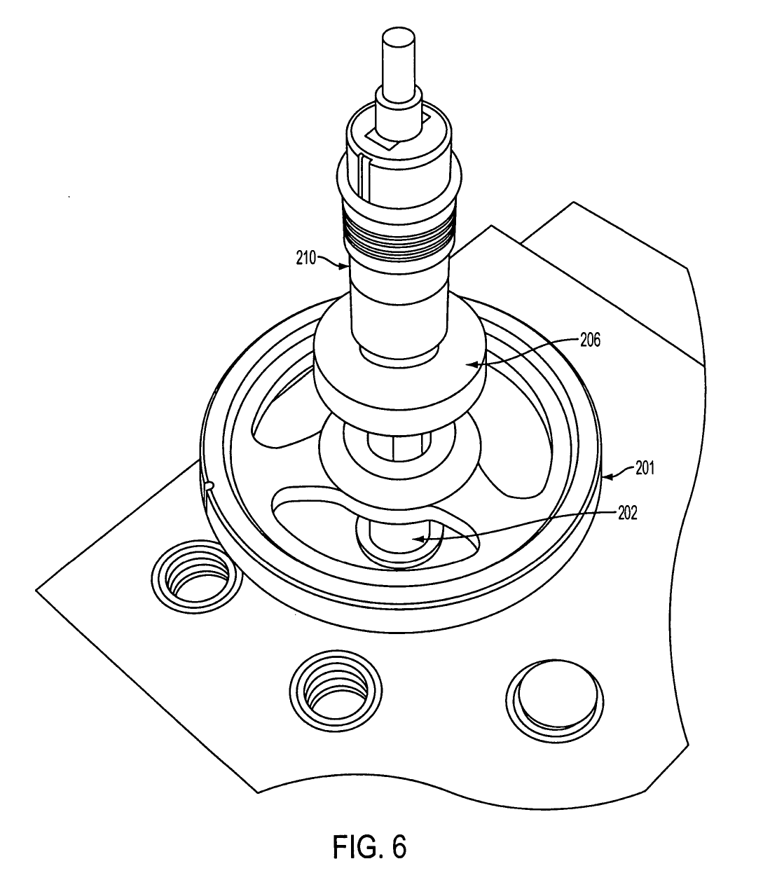

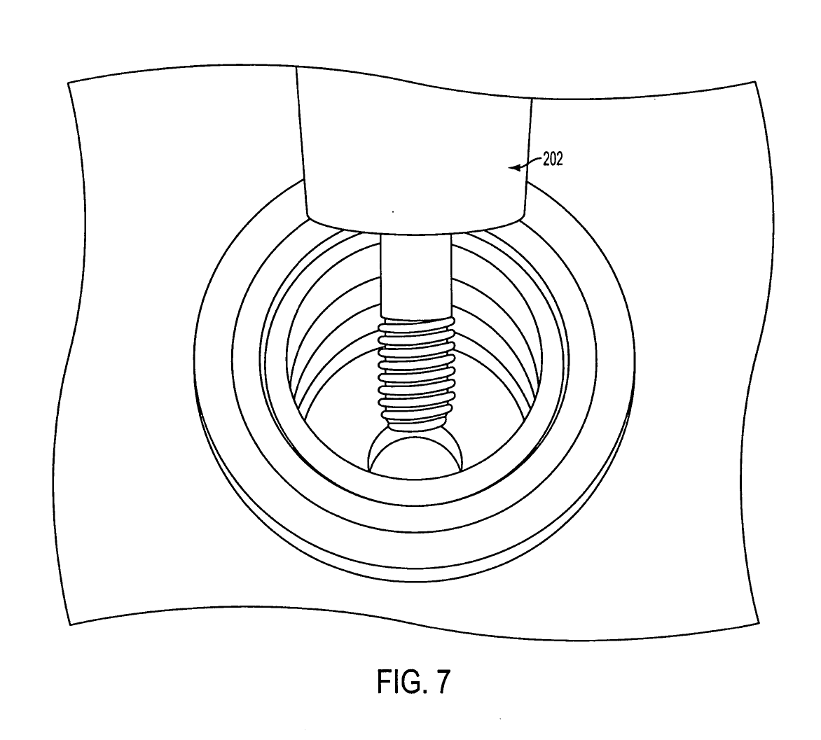

FIG. 5 is a perspective view of a jam tube bottom end 301 with a portion of collet bottom end 204 extending therefrom. As FIG. 5 illustrates, to utilize the invention as a fastener extractor, the fastener to be extracted is placed within collet bottom end 204. FIG. 6 is a top perspective view of a fastener extraction tool according to a preferred embodiment of the present invention. As Jam wheel 206 is rotated, collet bottom end 204 withdraws into jam tube bottom end 301, thereby constricting collet bottom end 204 around the fastener to be extracted. Once collect bottom end 204 has positively engaged the fastener, hand wheel 202 can be rotated, thereby causing the fastener to be extracted. FIG. 7 is a perspective view of a screw being removed by a fastener extraction tool according to a preferred embodiment of the present invention.

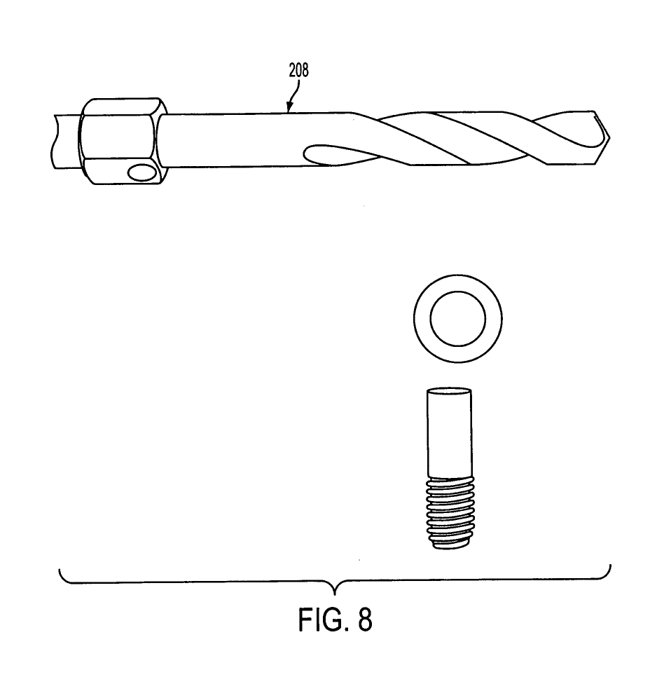

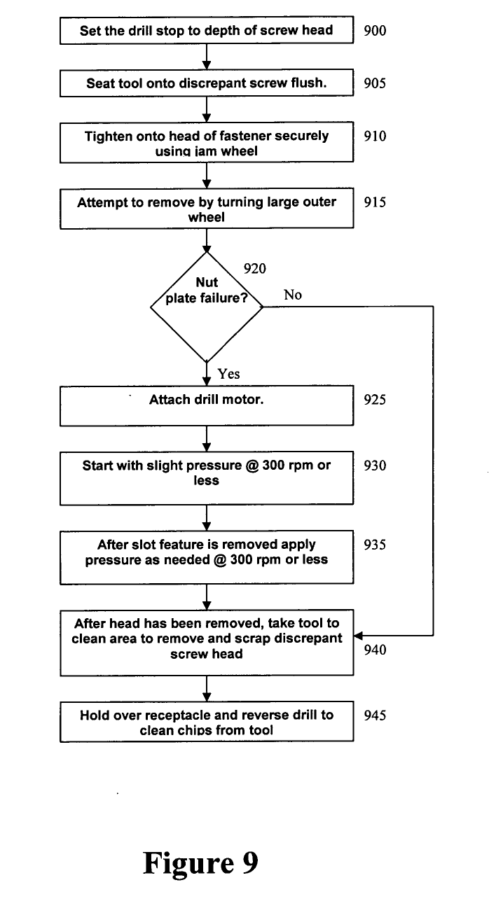

In the event the fastener cannot be extracted by hand, drill stop 210, and corresponding drill bit 208, can be used to facilitate fastener extraction. Drill bit 208 can be inserted into collet 203, and can make contact with the fastener. Drill stop 210 can preferably be configured to prevent drill bit 208 from extending beyond a desired depth, thereby preventing drill bit 208 from damaging any surrounding material. FIG. 8 is a profile view of a screw which has been removed using a fastener extraction tool according to a preferred embodiment of the present invention. Because drill bit 208 is contained within collet 203, and collet 203 is effectively sealed around the screw, all FOD generated during the drilling process is preferably collected within collet 203.

FIG. 9 provides a flow chart of a preferred method for using the present invention. As FIG. 9 illustrates, the method preferably includes setting the drill stop to limit its travel to approximately the depth of the screw head (Block 900) and seating the tool over the fastener to be extracted (Block 905). The collet is tightened onto the head or other protruding portion of the fastener using the jam wheel (Block 910). With the collet securely in place around the fastener, the outer wheel is turned in an effort to remove the fastener (Block 915). If the fastener can be extracted (Block 920), it is removed and the entire tool, including the extracted fastener, is preferably taken out of the clean room or to a proper FOD disposal site before the fastener is removed from the tool (Block 940) and any FOD is removed from the tool (Block 945). If the fastener turns in place (Block 920), this indicates that the material into which the fastener has been inserted, such as, but not limited to, a nut or nut plate, has broken free. A drill stop and corresponding drill are then preferably applied using slight pressure and a slow bit rotation rate (Block 930). Additional pressure can be added once the drill bit has worked its way through the damaged or remaining portion of the fastener (Block 935). Once the fastener can be extracted (Block 920), it is removed and the entire tool, including the extracted fastener, is preferably taken out of the clean room or to a proper FOD disposal site before the fastener is removed from the tool (Block 940) and any FOD is removed from the tool (Block 945).

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

I claim as my invention:

1. A method of removing a fastener using a fastener extraction tool, comprising:
attaching a jam tube to a hand wheel;
inserting a collet into the jam tube;
attaching a jam wheel to a first end of the collet to form a fastener extraction tool;
seating the fastener extraction tool onto an exposed surface of the fastener, wherein the exposed fastener surface fits within a second end of the collet;
tightening the fastener extraction tool onto the exposed fastener surface;
attempting to rotate the fastener extraction tool to remove the fastener; and
removing the fastener if the attempt is successful.

2. The method of claim 1, wherein the collet and jam wheel are attached by way of threads.

3. The method of claim 2, wherein rotation of the jam wheel causes the collet to engage the jam tube.

4. The method of claim 1, wherein the tightening step involves mechanically operating the jam wheel such that the collet engages the jam tube.

5. The method of claim 4, wherein mechanically operating the jam wheel causes at least a portion of the collet to contract.

6. The method of claim 1, further comprising, if the fastener removal attempt is unsuccessful, further performing:
setting a drill stop depth associated with the fastener extraction tool to be less than or equal to the length of the fastener;
attaching a drill motor to the fastener extraction tool;
removing at least a portion of the fastener using a drill bit;
turning the drill bit until the drill bit becomes coupled with the fastener or the drill stop depth is reached; and
removing the fastener.

7. The method of claim 6, wherein the drill bit comprises a left-hand threaded bit.

8. The method of claim 1, further comprising taking the tool to a clean area to remove foreign object debris from the tool.

9. The method of claim 1, wherein the collet is chosen such that the head of an MD112-1003-xxx type screw fits within the collet.

10. The method of claim 9, wherein the outer diameter of the jam tube fits in a ⅝″ diameter hole.

11. An apparatus for removing a damaged fastener, comprising:
a hand wheel;
a jam tube, operably coupled to the hand wheel;
a collet, wherein at least a portion of the collet fits within at least a portion of the jam tube, the collet being formed to create a tube;
a jam wheel, wherein the jam wheel is operably coupled to the collet; and
a damaged fastener, wherein at least a portion of the damaged fastener fits within at least a first end of the collet tube.

12. The apparatus of claim 11, wherein at least a portion of the collet is tapered, with the larger end having at least one slot.

13. The apparatus of claim 12, wherein operation of the jam wheel causes the collet to engage the jam tube.

14. The apparatus of claim 13, wherein the at least a portion of the damaged fastener fits within the slotted end of the collet.

15. The apparatus of claim 14, wherein engaging of the collet and the jam tube causes the collet to contract around the at least a portion of the damaged fastener.

16. The apparatus of claim 11, wherein rotation of the hand wheel causes the apparatus to rotate.

17. The apparatus of claim 11, further comprising a drill bit, wherein the drill bit is selected to fit inside the collet tube.

18. The apparatus of claim 17, wherein a drill stop is connected to the drill bit, thereby limiting the drill bit travel within the apparatus.
